(19) United States
(12) Patent Application Publication
(10) Pub. No.: US 2007/0257245 A1
(43) Pub. Date: Nov. 8, 2007

(54) Pipe rail system

(76) Inventor: Bruce Howard Patterson, Austin, TX (US)

Correspondence Address: Brian Rogers;Office of the General Counsel, 2401 South 31st Street, Temple, TX, 76508, US

(21) Appl. No.: 11/698,711

(22) Filed: Jan. 25, 2007

Related U.S. Application Data
(60) Provisional application No. 60/762,198, filed on Jan. 25, 2006.

(51) Int. Cl. E04F 11/18; E04H 17/00; F16B 9/00

(52) U.S. Cl. 256/65.07

(57) ABSTRACT

Provided herein is a composite metal pipe fitting comprising a substantially cylindrical metal body and a metal disk securely fitted in a cross-sectional position inside the body. Also provided herein is a method comprising fashioning a cylindrical metal body to comprise a first inside diameter and second inside diameter; fixing a metal disk having a hole against the first inside diameter in a cross-sectional position of the cylindrical metal body; and from the body and disk, forming a pipe fitting having an intersecting pipe receiving configuration at a proximal end and a coaxial pipe receiving configuration at a distal end of the body. Further provided herein is a hand rail system comprising a pipe fitting, the pipe fitting comprising a cylindrical metal body, a first inside diameter a second inside diameter, a metal disk fitted to the first inside diameter in a cross-sectional position in the cylindrical metal body, an intersecting pipe receiving configuration at a proximal end, and a coaxial pipe receiving configuration at a distal end. The hand rail system further comprises an intersecting pipe fitted to the proximal end and a coaxial pipe fitted to the distal end.

### CROSS-REFERENCE TO RELATED APPLICATIONS

The content of this application is related to the content of, and claims the benefit of priority to the filing date of, provisional patent application No. 60/762,198, which is incorporated herein by reference.

### STATEMENT REGARDING FEDERALLY SPONSORED RESEARCH OR DEVELOPMENT

Not applicable.

### SUMMARY

In various embodiments, provided herein is a composite metal pipe fitting comprising a substantially cylindrical metal body and a metal disk securely fitted in a cross-sectional position inside the body. In other embodiments, provided herein is a method comprising fashioning a cylindrical metal body to comprise a first inside diameter and second inside diameter; fixing a metal disk having a hole against the first inside diameter in a cross-sectional position of the cylindrical metal body; and from the body and disk, forming a pipe fitting having an intersecting pipe receiving configuration at a proximal end and a coaxial pipe receiving configuration at a distal end of the body. Further provided herein is a hand rail system comprising a pipe fitting, the pipe fitting comprising a cylindrical metal body, a first inside diameter a second inside diameter, a metal disk fitted to the first inside diameter in a cross-sectional position in the cylindrical metal body, an intersecting pipe receiving configuration at a proximal end, and a coaxial pipe receiving configuration at a distal end. The hand rail system further comprises an intersecting pipe fitted to the proximal end and a coaxial pipe fitted to the distal end.

### BRIEF DESCRIPTION OF THE DRAWINGS

FIG. 1a is a cutaway view of a pipe fitting in accordance with embodiments of the invention;

FIG. 1b is also a cutaway view of a pipe fitting in accordance with embodiments of the invention;

FIG. 2 is a cross-sectional view of a reinforcing rod in accordance with embodiments of the invention;

FIG. 3 is an illustration of a pitch pop rivet fitting in accordance with embodiments of the invention;

FIG. 4 is an illustration of a corner pop rivet fitting in accordance with embodiments of the invention; and

FIG. 5 is an illustration of a hand rail system comprising a pipe rail system including reinforcing rods in accordance with embodiments of the invention.

### DETAILED DESCRIPTION

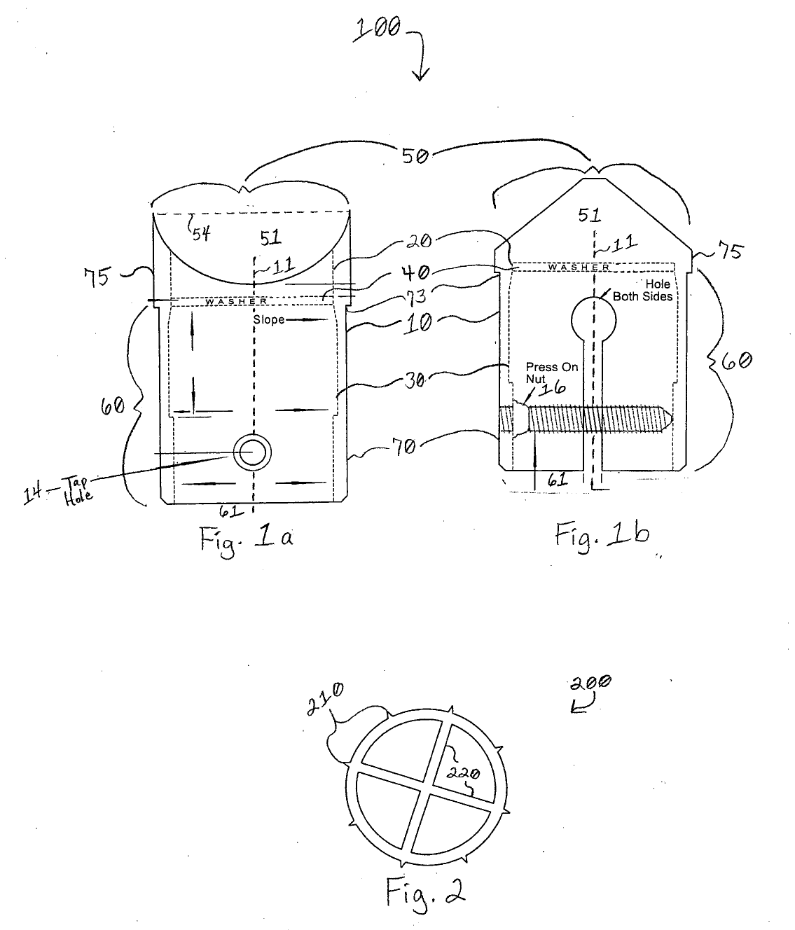

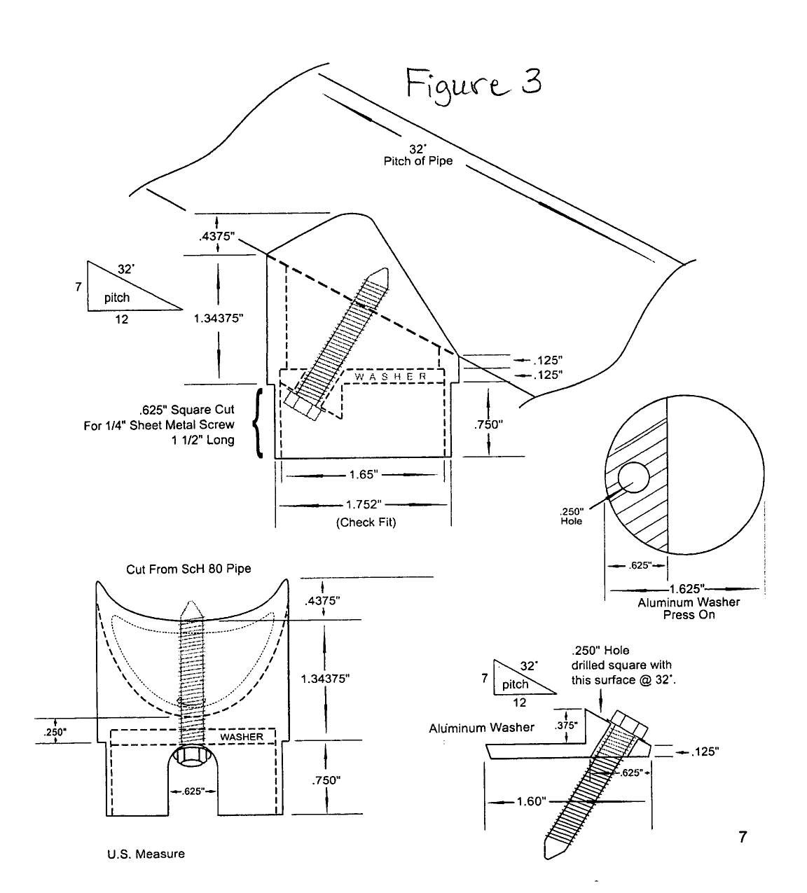

Disclosed herein are pipe rail systems and methods of producing pipe rail systems. FIGS. 1a and 1b illustrate a metal pipe fitting 100 used in pipe rail systems in accordance with embodiments of the present invention. FIGS. 1a and 1b are cutaway views of the same generally cylindrical pipe fitting where the difference between the views is about a ninety degree rotation of the fitting about the cylindrical center axis 11. The fitting comprises a hollow cylindrical metal body 10, a first inside diameter 20, a second inside diameter 30, and a metal disk (e.g.—a washer) 40 in a cross-sectional position in the body 10. The fitting further comprises an intersecting pipe receiving configuration 50 at a proximal end 51 and a coaxial pipe receiving configuration 60 at a distal end 61.

Depending on the application, the features of the hollow cylindrical metal body (or “body”) 10 may vary. The body 10 may be comprised of aluminum, steel, stainless, steel, iron, brass, and alloys thereof. The body may be further comprised of schedule 40, schedule 80, schedule 100, schedule 120, or schedule 160 pipe. As for dimensions, in various embodiments the hollow cylindrical metal body 10 comprises an outside diameter from about 0.75 to about 3.5 inches; alternatively, from about 1 to about 3 inches; or alternatively, from about 1.5 to about 2.5 inches. Such a body generally comprises a length from about 1 to about 4 inches; alternatively from about 1.5 to about 3.5 inches; or alternatively, from about 2 to about 3 inches. The first inside diameter 20 of the body may be in the range from about 0.5 to about 2.75 inches. The second inside diameter 30 may be in the range from about 0.6 to about 2.8 inches.

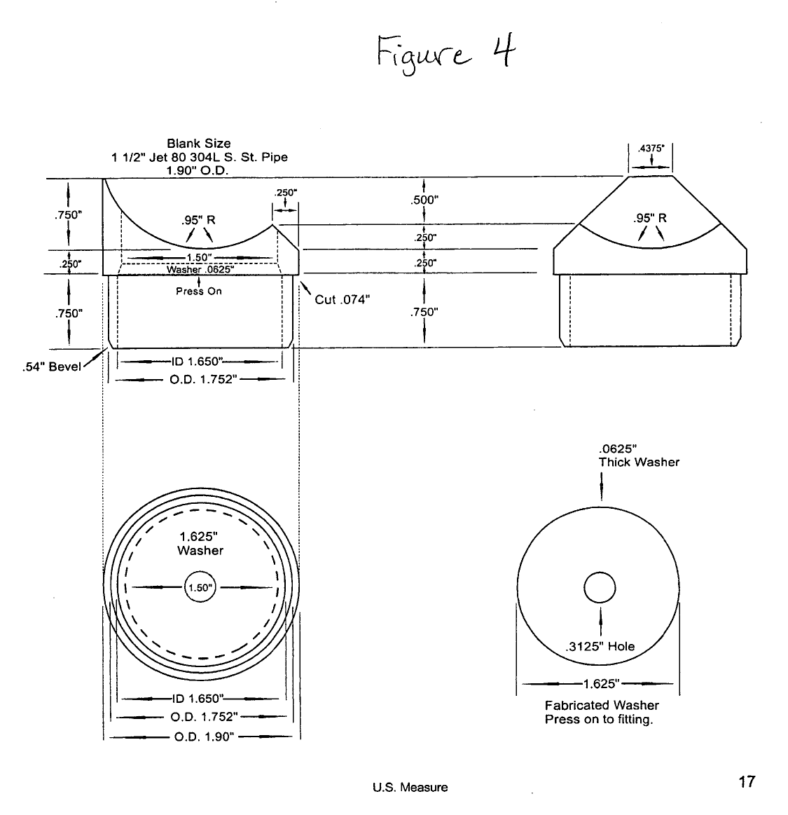

The metal disk 40 is in a cross-sectional position inside the body 10. Like the body, the disk may be comprised of aluminum, steel, stainless, steel, iron, brass, and alloys thereof. The disk 40 further comprises a hole (not illustrated). In some embodiments the disk is substantially flat and the hole is substantially at the center of the disk. In other embodiments, such as when the disk is employed in a pitched pipe fitting (see FIG. 3), the portion of the disk forming the hole may not be flush with the remainder of the disk, that is—the disk is not substantially flat, and the hole may not be centered within the diameter of the disk. The hole in the disk makes it possible for a screw (not illustrated) of the appropriate size to penetrate the hole and complete coupling of the fitting 100 to an intersecting pipe (not illustrated) at the proximal end 51 of the fitting 100. In certain embodiments the disk is a conventional washer comprised of the appropriate material. Dimensionally, the disk may comprise a thickness from about 0.05 inches to about 0.33 inches thick; alternatively, from about 0.1 to about 0.25 inches thick. The disk may further comprise a diameter from about 0.75 inches to about 3 inches; alternatively, from about 1 to about 2.5 inches.

The embodiment illustrated by FIGS. 1a and 1b is of a t-bracket tange fitting comprising a conventional tap hole 14 and press on nut 16. In various other embodiments, the configuration of the fitting may comprise a pop rivet fitting (see FIG. 3), a pitch pipe fitting (FIG. 3), a corner fitting (see FIG. 4), or combinations thereof.

The fitting of FIGS. 1a and 1b comprises an intersecting pipe receiving configuration 50 at the proximal end 51. The intersecting pipe receiving configuration 50 may be designed to conform to an intersecting pipe (not illustrated) having a particular size and shape. The configuration 50 at the proximal end 51 of the fitting in FIGS. 1a and 1b is designed to receive a circular pipe having a diameter that fits flush to the diameter 54 of the pipe receiving configuration 50. The intersecting pipe may intersect the fitting at any angle, such as may warrant a pitch pipe fitting design (see FIG. 3) or corner pipe fitting design (see FIG. 4) in accordance with other embodiments of the invention.

The fitting of FIGS. 1a and 1b further comprises a telescoping configuration 60 at the distal end 61. The telescoping configuration 60 is a feature of the body 10 of the fitting 100 comprising a first outside diameter 70 and second outside diameter 75. The portion of the length of the body 10 comprising a first outside diameter 70 may be telescopically inserted to a coaxial pipe (not shown), thus coupling the fitting 100 to the pipe. This embodiment of the pipe fitting features a male telescoping configuration, while other embodiments may feature a female telescoping configuration. A shoulder 73 may be formed where the first outside diameter 70 changes to the second outside diameter 75. The coaxial pipe may telescopically fit over the telescoping configuration 60 of the body 10 and stop at the shoulder 73, where the shoulder limits the telescopic overlap of the body 10 and coaxial pipe. In embodiments, the first outside diameter 70 of the fitting comprises from about 0.75 to about 2.75 inches, and the second outside diameter 75 comprises from about 1 to about 3 inches.

Thus, a fitting 100 may fit two pipes together by coupling to an intersecting pipe at the proximal end 51 and a coaxial pipe at the distal end 61. Fitting the two pipes together may form a pipe rail system in accordance with embodiments of the invention. Such a pipe rail system comprises: a pipe fitting in accordance with embodiments described herein; an intersecting pipe fitted at the proximal end of the pipe fitting; and a coaxial pipe fitted to the distal end of the pipe fitting. Such a pipe rail system may be a component of a hand rail, a ladder, a rack, or shelves, which may be comprised of multiple pipe rail systems.

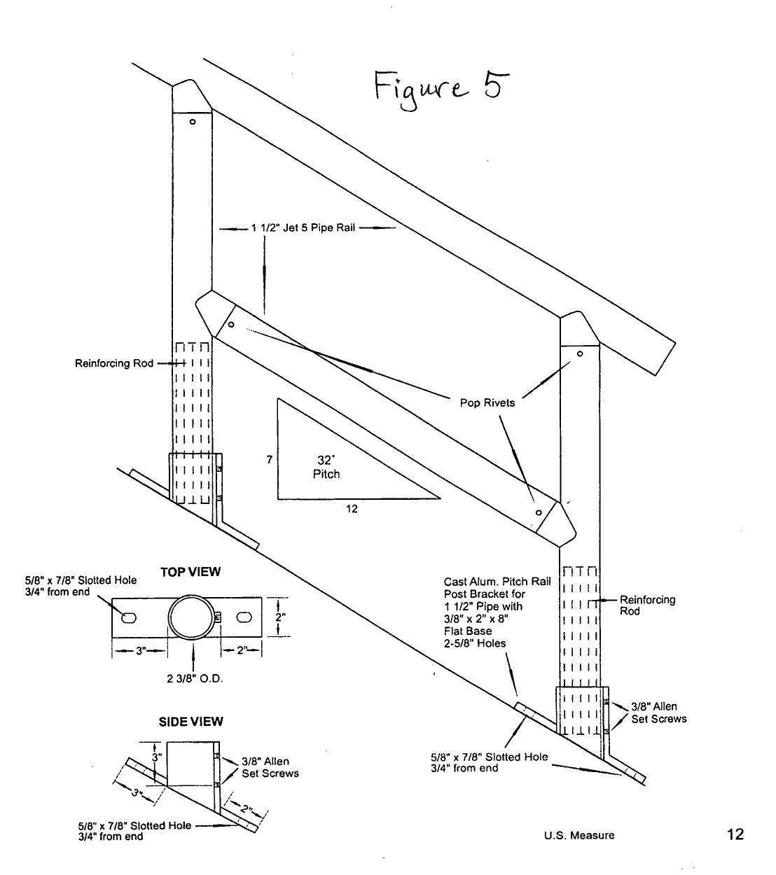

A reinforcing rod may be another component of a pipe rail system. FIG. 5 illustrates an embodiment of a pipe rail system incorporating reinforcing rods. Such a reinforcing rod may be inserted into a pipe in a pipe rail system in order to reinforce the strength and stability of the system. FIG. 2 is a cross-sectional view of an embodiment of such a reinforcing rod 200. In various embodiments, the rod comprises one or more points 210 or ridges that may facilitate insertion of the reinforcing rod into a pipe. Depending on the application, it may be desirable for points to be arranged in pairs, such that the points in a pair are opposite each other along the outside of the rod. In the example of FIG. 2 the reinforcing rod comprises a circular cross-section and point pairs are one hundred eighty degrees (180°) apart. In addition to points 210, the rod may further comprise one or more reinforcing ribs 220. The reinforcing ribs 220 may add strength to the rod and pipe to resist stresses. As for materials, the reinforcing rod may be comprised of aluminum, brass, and alloys thereof. In specific embodiments of a pipe rail system, an aluminum reinforcing rod is used to reinforce a stainless steel pipe rail system to meet strength/stress requirements normally met by rail systems comprised of solid steel rod. Methods of forming the reinforcing rod may comprise extrusions. The extruded rod may be formed according to specifications and tolerances such that the rod may insert securely into the pipe.

In various embodiments, a method of producing a pipe rail system as described herein may comprise: fashioning a hollow cylindrical metal body to comprise a first inside diameter and second inside diameter; securely fixing a metal disk against the first inside diameter in a cross-sectional position of the cylindrical metal body; and, from the body and disk, forming a pipe fitting comprising an intersecting pipe receiving configuration at a proximal end and a coaxial receiving configuration at a distal end of the body. To the pipe fitting may be fitted an intersecting pipe to the proximal end and a coaxial pipe to the distal end in order to complete the pipe rail system. The pipe rail system may be incorporated as a component into a hand rail, ladder, rack, or shelves. Such applications may incorporate multiple pipe rail systems.

While exemplary embodiments of the invention have been shown and described, such embodiments are not intended to be limiting. Modifications of the described invention embodiments can be made by one skilled in the art without departing from the spirit and teachings of the invention. Many variations are possible and are within the scope of the invention. Use of broader terms such as comprises, includes, having, etc. should be understood to be open ended. The scope of protection is not limited by the description set out above, but is only limited by the claim that follows, that scope including all equivalents of the subject matter of the claim.

What is claimed is:

1. A composite metal pipe fitting comprising:
a substantially cylindrical metal body;
a metal disk securely fitted in a cross-sectional position inside the body.

2. The composite metal pipe fitting of claim 1 wherein the metal disk further comprises a hole.

3. The composite metal pipe fitting of claim 1 wherein the metal disk comprises a washer.

4. The composite metal pipe fitting of claim 1 wherein the metal disk comprises a thickness from about 0.05 to about 0.25 inches thick.

5. The composite metal pipe fitting of claim 1 wherein the metal disk comprises a diameter from about 1 to about 3 inches.

6. The composite metal pipe fitting of claim 1 wherein the metal body comprises a length from about 1.5 to about 3.5 inches.

7. The composite metal pipe fitting of claim 1 wherein the metal body comprises a first outside diameter and a second outside diameter.

8. The composite metal pipe fitting of claim 1 wherein the metal body comprises aluminum, steel, stainless steel, iron, brass, and combinations and alloys thereof.

9. The composite metal pipe fitting of claim 1 wherein the metal body comprises a section of schedule 40, schedule, 80, schedule 100, schedule 120, schedule 160 pipe, and combinations thereof.

10. The composite metal pipe fitting of claim 7 wherein the first outside diameter comprises from about 1 to about 3 inches.

11. The composite metal pipe fitting of claim 7 wherein the second outside diameter comprises from about 0.75 to about 2.75 inches.

12. The composite metal pipe fitting of claim 1 wherein the metal body comprises a first inside diameter and a second inside diameter.

13. The composite metal pipe fitting of claim 12 wherein the first inside diameter comprises from about 0.5 to about 2.75 inches.

14. The composite metal pipe fitting of claim 12 wherein the second inside diameter comprises from about 0.6 too about 2.8 inches.

15. The composite metal pipe fitting of claim 1 wherein the fitting comprises a t-bracket pipe fitting, a pitch pipe fitting, a tange fitting, a pop rivet fitting, and combinations thereof.

16. The pipe fitting of claim 1 further comprising a t-bracket receiving configuration at a proximal end, a pitch t-bracket receiving configuration at a proximal end, a telescoping configuration at a distal end, a male telescoping configuration at a distal end, and combinations thereof.

17. A method comprising:
fashioning a cylindrical metal body to comprise a first inside diameter and second inside diameter;
fixing a metal disk having a hole against the first inside diameter in a cross-sectional position of the cylindrical metal body; and
from the body and disk, forming a pipe fitting having an intersecting pipe receiving configuration at a proximal end and a coaxial pipe receiving configuration at a distal end of the body.

18. The method of claim 17 further comprising fitting an intersecting pipe to the proximal end and a coaxial pipe to the distal end of the pipe fitting.

19. The method of claim 17 further comprising incorporating the pipe fitting into a rail system.

20. A hand rail system comprising:
a pipe fitting comprising:
a cylindrical metal body;
a first inside diameter;
a second inside diameter;
a metal disk fitted to the first inside diameter in a cross-sectional position in the cylindrical metal body;
an intersecting pipe receiving configuration at a proximal end; and
a coaxial pipe receiving configuration at a distal end;
an intersecting pipe fitted to the proximal end; and
a coaxial pipe fitted to the distal end.

21. The hand rail system of claim 20 wherein the system is a component of a hand rail, a ladder, a rack, or shelves.
